(19) United States
(12) Patent Application Publication
(10) Pub. No.: US 2011/0263208 A1
(43) Pub. Date: Oct. 27, 2011

(54) Cognitive radio sensing method and system

(76) Inventor: Ahmed M. Barnawi, Jeddah (SA)

(21) Appl. No.: 12/662,656

(22) Filed: Apr. 27, 2010

(51) Int. Cl. H04B 17/00

(52) U.S. Cl. 455/67.11

(57) ABSTRACT

The cognitive radio system and method uses a wideband chirp signal. A cognitive radio base station broadcasts the low power reference wideband chirp signal with bandwidth covering the sensed spectrum. At the receiver, a Fast Fourier Transform is applied to the output of a chirp signal matched filter. The filter output is fed to decision circuitry, where a threshold value is set to decide the minimum spike's amplitude to determine frequencies utilized by primary users. Using reference chirp signal and its matched filter eases sensing computational complexity and improves the quality of sensing, thereby offering enhanced cognition at the CR receiver.

### BACKGROUND OF THE INVENTION

1. Field of the Invention

The present invention relates to radio systems providing wireless voice and data communications, and more particularly, to a cognitive radio sensing system and method that is capable of changing its operating parameters responsive to a changing and unanticipated radio environment and performs such cognitive functions using a wideband chirp signal to reduce computational complexity.

2. Description of the Related Art

Most traditional radios have their technical characteristics set at the time of manufacture. More recently, radios have been built that self-adapt to one of several preprogrammed radio frequency (RF) environments that might be encountered. The main idea of cognitive radio is to improve the utilization of the scarce radio resources. A cognitive radio can sense its environment and alter its technical characteristics and operational behavior to benefit both itself and its geographical and spectral neighbors. The ability to sense and respond intelligently distinguishes cognitive radios from fixed or adaptive radios. A cognitive radio can respond intelligently to an unanticipated event, e.g., a wireless environment (channel) that it never encountered before. The result is enhanced performance (throughput, quality of service (QOS), and security) for the cognitive radio's network and reduced interference to other networks. The Oxford English Dictionary (OED) defines “cognitive” as: “pertaining to cognition, or to the action or process of knowing”. “Cognition” is defined as “the action or faculty of knowing taken in its widest sense, including sensation, perception, conception, etc., as distinguished from feeling and volition”. Given these definitions, the process of sensing an existing wireless channel, evolving a radio's operation to accommodate the perceived wireless channel, and evaluating what happens is appropriately termed a cognitive process. Most cognitive computing systems to date have been based on sensing methodologies, which result in high computational complexity.

The success of cognitive transmission strategies relies on the quality and quantity of the cognition systems at the receiver. Such cognition is acquired through rigorous sensing of the radio channel and an ability to characterize the interference. Based on the sensing functionality, the transmission facilities should adapt their transmissions accordingly.

The problem of spectrum sensing and characterization is a typical trade-off problem where the accuracy and the simplicity are inversely related. The most widely known sensing techniques are match filtering, energy detection, and cyclostationary features detection. While match filtering is the optimal detection technique, a practical implementation is difficult due to system requirements. At a lower level of difficulty, the performance of cyclostationary features detection is near optimal. However, system complexity is non-trivial. Energy detection is the least complex and most inaccurate among the three methods.

Thus, a cognitive radio sensing method and system solving the aforementioned problems is desired.

### SUMMARY OF THE INVENTION

The cognitive radio system implements the optimal detection technique of match filtering in a practical manner, given real world system requirements.

A cognitive radio base station broadcasts a low power reference wideband chirp signal with bandwidth covering the sensed spectrum. At the receiver, a Fast Fourier Transform is applied to the output of a chirp signal matched filter. The filter output is fed to decision circuitry, where a threshold value is set to decide the minimum amplitude of utilized frequencies. Using the characteristics of the chirp signal matched filter's output eases sensing computational complexity and improves the quality of sensing, thereby offering enhanced cognition at the cognitive radio receiver.

These and other features of the present invention will become readily apparent upon further review of the following specification and drawings.

### BRIEF DESCRIPTION OF THE DRAWINGS

FIG. 1A is a plot showing a cognitive radio sensing chirp signal used in a cognitive radio sensing system according to the present invention.

FIG. 1B is a plot showing a cognitive radio sensing chirp spectrum used in a cognitive radio sensing system according to the present invention.

FIG. 2 is a block diagram showing the system architecture utilized by in a cognitive radio sensing method according to the present invention.

FIG. 3 is a block diagram showing a simulation model of a cognitive radio sensing method according to the present invention.

FIG. 4 is a cognitive radio sensing received chirp spectrum used in a cognitive radio sensing system according to the present invention.

FIG. 5 is a plot showing SINR versus normalized d.

FIG. 6 is a plot showing delay versus normalized d.

Similar reference characters denote corresponding features consistently throughout the attached drawings.

### DETAILED DESCRIPTION OF THE PREFERRED EMBODIMENTS

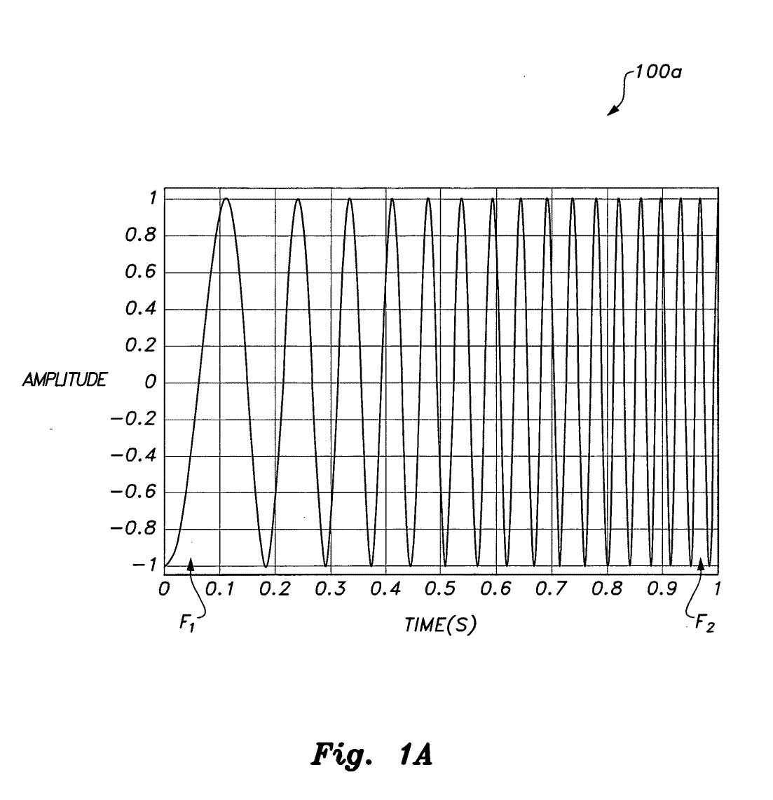

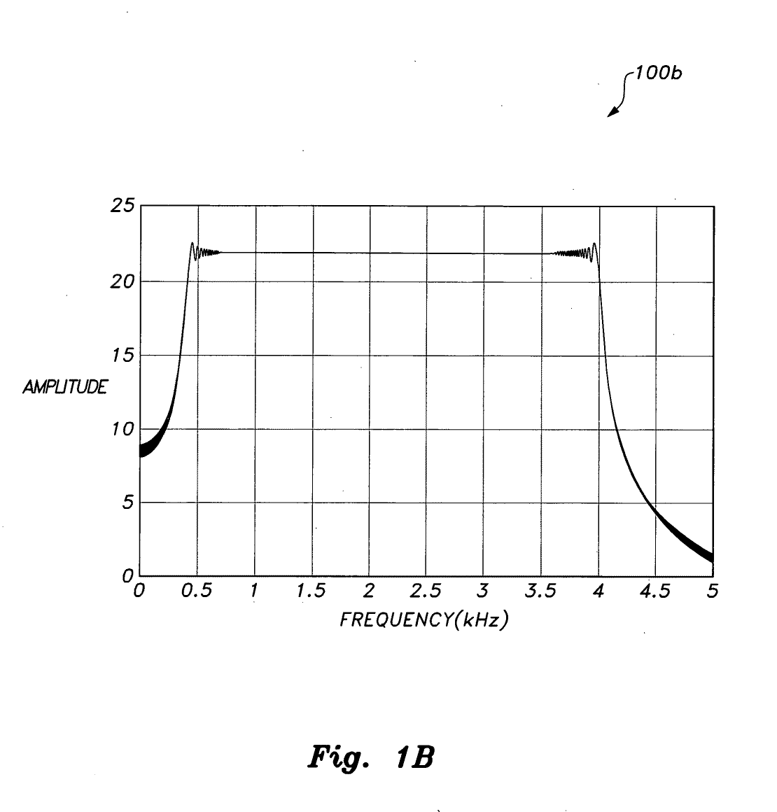

The cognitive radio sensing method and system uses wideband chirp signal frequency modulation for a digital signal. Linear frequency (chirp) modulation is a result of linear frequency modulation for digital signal. The instantaneous frequency of the chirp signal increases or decreases linearly with time. As shown in FIG. 1A, the bandwidth of a chirp signal, 100a, extends from the starting frequency sweep, f₁, to the final frequency sweep f₂. With a proper choice for processing gain, i.e., FT product, where T is the bit period, the spectrum of the chirp signal has a distinctive near square shape 100b, as shown in FIG. 1B.

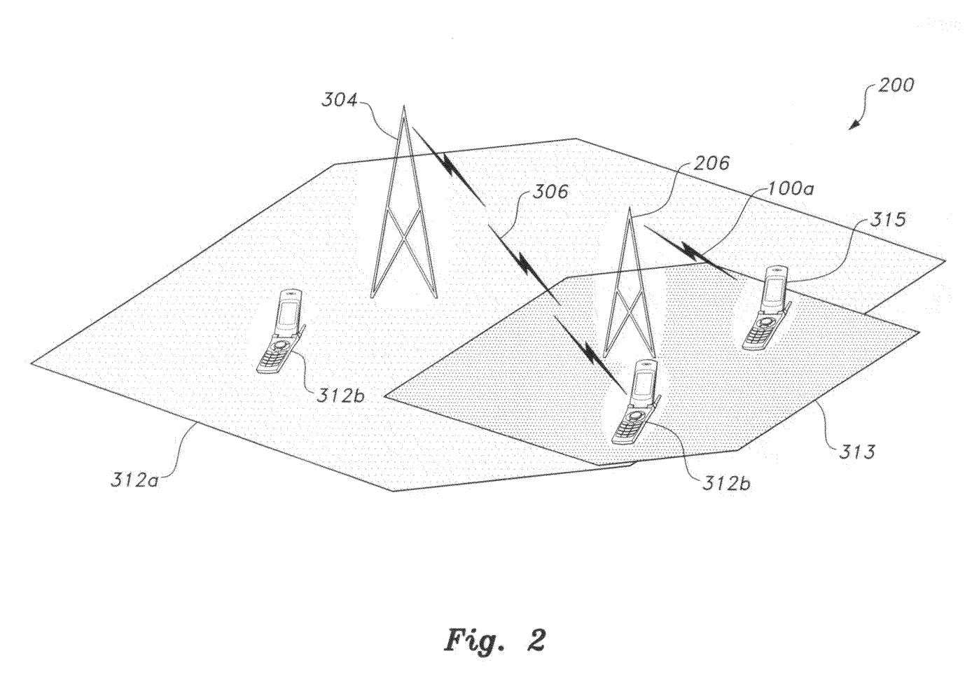

As shown in FIG. 2, the system architecture is a hybrid network 200 comprising a primary radio network 312 and a cognitive “adaptive” radio network 313. The two networks 312 and 313 coexist without being physically connected.

The primary radio network 312a is comprised of a primary base station 304 serving primary “licensed” users over the primary coverage area. The primary base station 304 performs normal functions of a base station.

The cognitive radio network 313 of system 300 is adaptive and comprises cognitive radio base station 206, which serves cognitive radio user devices 315. The coverage area of cognitive radio network 313 overlaps with the coverage area of primary network 312a, which serves primary network user devices 312b. The cognitive radio user devices 315 have a transmission algorithm that allows devices 315 to transmit only after the devices 315 sense the availability of the required radio resources. The transmission algorithm guarantees that no excessive interference from cognitive radio user devices 315 occurs at the primary user devices 312b.

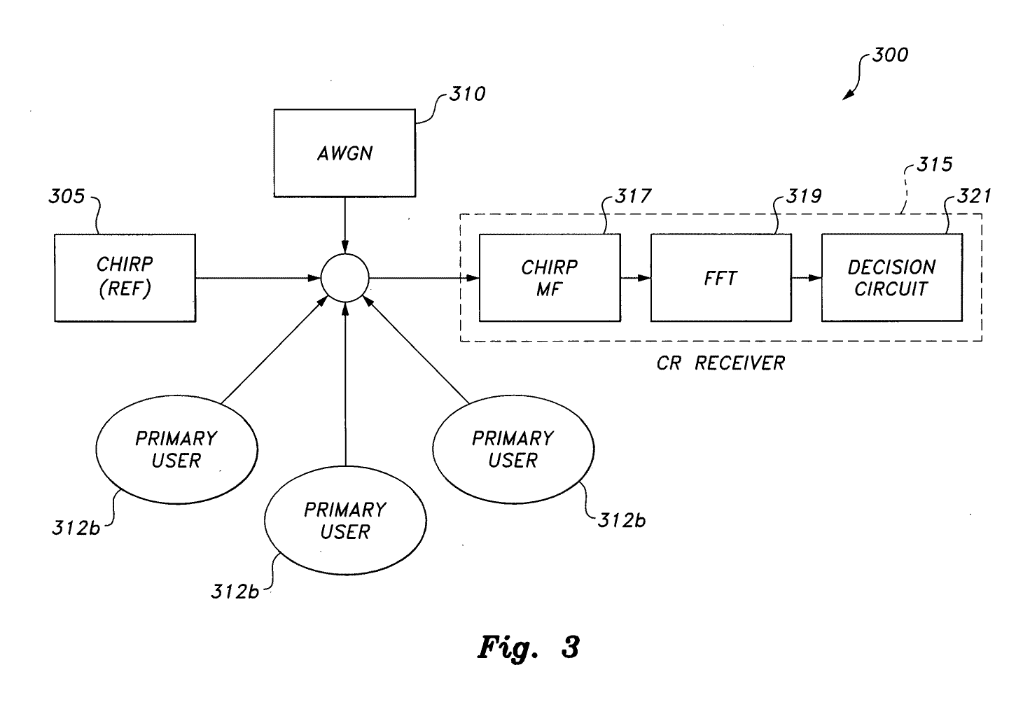

FIG. 3 shows a block diagram of system 300, which is simulated using Matlab. The simulation of cognitive radio system 300 includes the step of the cognitive radio base station 206 broadcasting a low power reference chirp signal 100a using chirp generator 305. Along with transmissions from primary user devices 312b and electromagnetic additive white Gaussian noise (AWGN 310), the reference chirp signal 100a is received by the CR user device 315, which employs a chirp signal matched filter 317. Exemplary CR user device 315 may be a cellular telephone, smart phone, or other radiotelephone transceiver.

Fast Fourier Transform (FTT) algorithm 319 is applied to the output of matched filter circuitry 317. The output of FTT algorithm 319 is fed into decision circuitry 321, which is set at a threshold value to decide whether the signal of a primary user device 312b interferes with the reference chirp signal 100a.

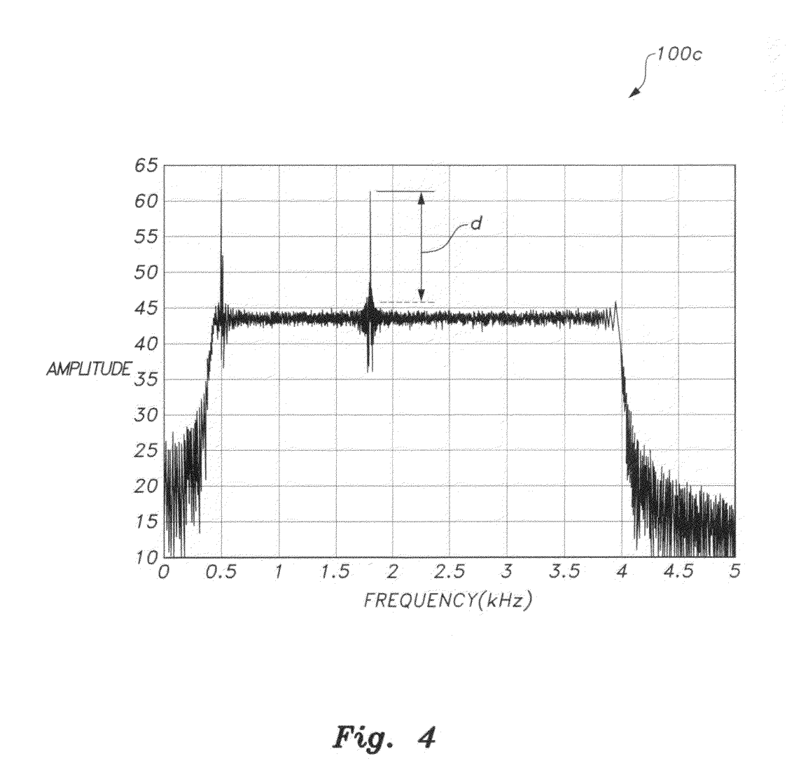

As shown in FIG. 4, interfering frequencies (signals from primary user devices 312b) appear as spikes, i.e., peaks, rising above the flat-top 100c of received chirp reference 100a spectrum in the presence of AWGN, simulated by AWGN generator 310. The Signal to Interference plus Noise Ratio (SINR) for interfering (primary user) signal is 20 dB.

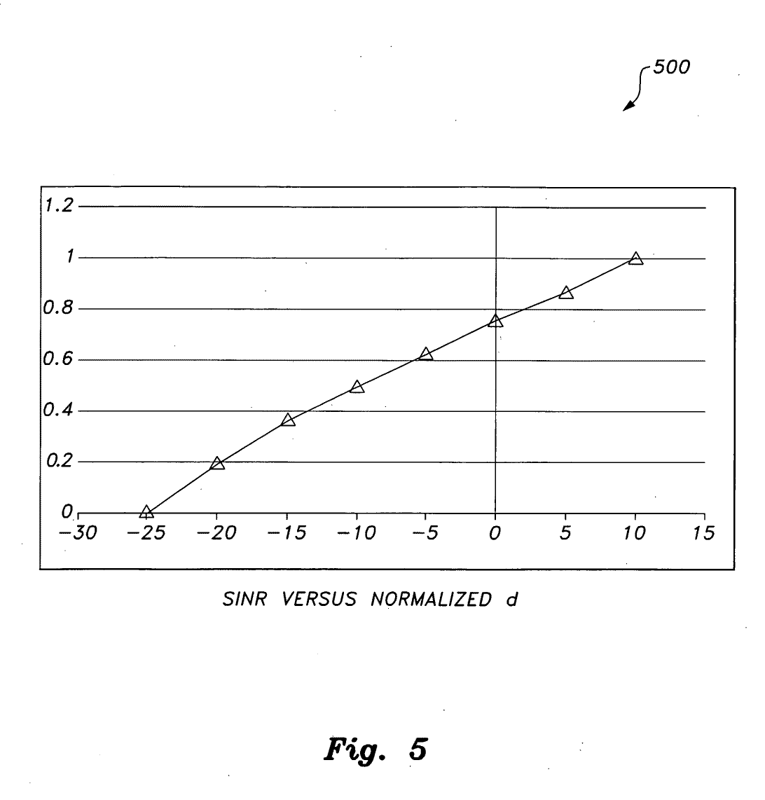

As shown in FIG. 5, plot 500 displays the carrier's SINR versus d, normalized to a value of d at SINR=10 dB, which measures the distance between the peak of the carrier's spike and the threshold value set just above the noisy flat top of the FFT algorithm 319 output. The value of d=0 dB signifies that the spike is no longer distinguishable from the noise and therefore the probability of a false alarm is great. Preferably, the noise floor determines the threshold value for the decision circuit 315, since ddecreases as SINR decreases. For the MATLAB™ simulation, it is shown that d=0 at SINR=−25 dB which is an extremely low SINR value. The SINR values were calculated assuming that transmissions of primary user devices 312b are in synchronization with the referenced chirp signal 100a.

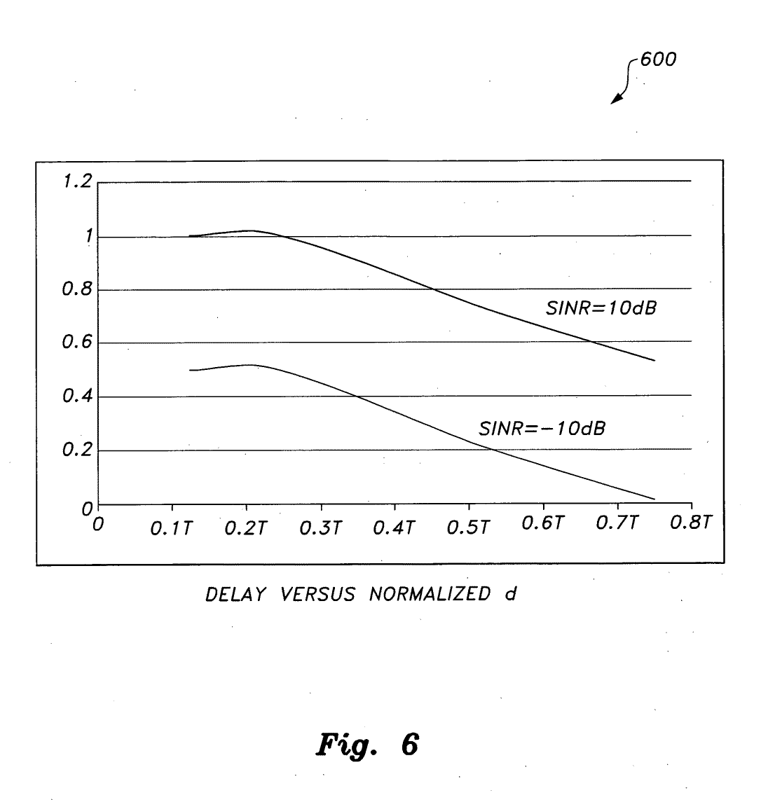

Plot 600 of FIG. 6 shows Delay versus normalized d, which investigates the effect of a more realistic scenario where both networks (primary 312a and cognitive 313) are not synchronized. The plot 600 shows how d changes with respect to the delay between primary user's signal and the reference chirp signal. For example, if the primary user's signal is delayed by 0.5T seconds, where T is the bit period, d drops by 25%. Nonetheless, the system is tolerant to delay up to 0.25T seconds in both SINR cases shown.

It is to be understood that the present invention is not limited to the embodiment described above, but encompasses any and all embodiments within the scope of the following claims.

I claim:

1. A cognitive radio sensing method, comprising the step of broadcasting a low power reference chirp signal having a bandwidth covering a predetermined sensing spectrum of a cognitive radio receiver.

2. The cognitive radio sensing method according to claim 1, further comprising the step of performing said broadcasting step of reference chirp signal in a cognitive radio network coverage area, the cognitive radio network coverage area overlapping a coexistent primary radio network coverage area.

3. A cognitive radio sensing method, comprising the steps of:
receiving a low power reference chirp signal having a bandwidth covering a sensed spectrum of a cognitive radio system;
transforming, in a frequency domain, an output of the chirp signal matched filter, resulting in a transformed output signal; and
determining the frequencies of interfering primary users signals based on a selected feature of their spectral amplitudes above a threshold level.

4. The cognitive radio sensing method according to claim 3, further comprising performing said receiving step reference chirp signal in a cognitive radio network coverage area, the cognitive radio network coverage area overlapping a coexistent primary radio network coverage area.

5. The cognitive radio sensing method according to claim 3, wherein said step of transforming in a frequency domain is accomplished by performing a Fast Fourier Transform (FED on said optimally received low power reference chirp signal.

6. The cognitive radio sensing method according to claim 3, wherein the selected feature of said transformed output signal is compared to the threshold value, the threshold value being set above a noisy flat top portion of said transformed output signal, to determine the frequencies of interfering primary users' spikes above the threshold value.

7. A cognitive radio sensing system, comprising:
means for receiving a low power reference chirp signal having a bandwidth covering a sensed spectrum of a cognitive radio system;
means for filtering the chirp signal;
means for transforming in a frequency domain an output of the
means for filtering the chirp signal, thereby providing a frequency domain transformed output signal; and
means for determining the frequencies of interfering primary users' signals based on a selected feature of their spectral amplitudes above a threshold level.

8. The cognitive radio sensing system according to claim 7, wherein the cognitive radio transceiver is located in a cognitive radio network coverage area, the cognitive radio network coverage area overlapping a coexistent primary radio network coverage area.

9. The cognitive radio sensing system according to claim 7, wherein the means for filtering the chirp signal comprises means for performing a Fast Fourier Transform (FFT) on an output signal of a chirp signal matched filter.

10. The cognitive radio sensing system according to claim 7, wherein the selected feature of the transformed output signal is a signal spike rising above the threshold level, the threshold level being determined just above a noisy floor of a flat top portion of the transformed output signal.

11. The cognitive radio sensing system according to claim 7, further comprising means for transmitting said low power reference chirp signal.

12. The cognitive radio sensing system according to claim 11, wherein said means for transmitting said low power reference chirp signal is located in a cognitive radio network coverage area, said cognitive radio network coverage area overlapping a coexistent primary radio network coverage area.
